(19) United States
(12) Patent Application Publication
(10) Pub. No.: US 2021/0055246 A1
(43) Pub. Date: Feb. 25, 2021

(54) HUMIDITY SENSOR

(71) Applicant: ELECTRONICS AND TELECOMMUNICATIONS RESEARCH INSTITUTE, Daejeon (KR)

(72) Inventors: Woo Seok YANG, Daejeon (KR); Sunghoon HONG, Daejeon (KR); Yong Suk YANG, Daejeon (KR); Bonjin KOO, Daejeon (KR)

(73) Assignee: ELECTRONICS AND TELECOMMUNICATIONS RESEARCH INSTITUTE, Daejeon (KR)

(21) Appl. No.: 16/684,214

(22) Filed: Nov. 14, 2019

(30) Foreign Application Priority Data
Aug. 21, 2019 (KR) 10-2019-0102570

(51) Int. Cl. G01N 27/22; H01G 4/008; H01G 4/14; H01G 4/40; H01Q 1/22; G06K 19/07

(52) U.S. Cl. CPC G01N 27/223; H01G 4/008; H01G 4/14; G06K 19/0723; H01Q 1/2208; G01N 27/226; H01G 4/40

(57) ABSTRACT

Provided is a humidity sensor including a support body, an RFID chip, an antenna, and a capacitor on the support body, a top cover sheet on the RFID chip and the antenna, and a hydrophobic material pattern on the capacitor, wherein the capacitor is exposed by the top cover sheet, the hydrophobic material pattern has a network shape including a plurality of holes, and an electrostatic capacitance of the capacitor changes according to humidity.

### CROSS-REFERENCE TO RELATED APPLICATIONS

This U.S. non-provisional patent application claims priority under 35 U.S.C. § 119 of Korean Patent Application No. 10-2019-0102570, filed on Aug. 21, 2019, the entire contents of which are hereby incorporated by reference.

### BACKGROUND

The present disclosure herein relates to a humidity sensor, and more particularly, to a humidity sensor including a capacitor.

Relative humidity may be measured by measuring an impedance change. Among devices for measuring the relative humidity by measuring the impedance change, there is a device using an electrostatic capacitive sensor including a sensitive dielectric material layer designed to absorb surrounding moisture. In such a sensor, a dielectric material layer is disposed between two electrodes, and the entirety thereof forms a capacitor. As humidity changes, an amount of water absorbed by the dielectric material layer also changes, and accordingly, a dielectric constant of the layer changes. In the end, an electrostatic capacitance of the capacitor changes, and the electrostatic capacitance is measured. Due to a high value of about 80 of the dielectric constant of the water, the change may be large.

### SUMMARY

The present disclosure provides a structure of a humidity sensor capable of measuring humidity with high accuracy within a fast response time.

An embodiment of the inventive concept provides a humidity sensor including: a support body; an RFID chip, an antenna, and a capacitor on the support body; a top cover sheet on the RFID chip and the antenna; and a hydrophobic material pattern on the capacitor, wherein the capacitor is exposed by the top cover sheet, the hydrophobic material pattern has a network shape including a plurality of holes, and an electrostatic capacitance of the capacitor changes according to humidity.

In some embodiments, the hydrophobic material pattern may include a polymer material or an organic-inorganic hybrid material.

In some embodiments, each of the holes may expose a top surface of a dielectric material of the capacitor.

In an embodiment, the RFID chip may convert a value of the electrostatic capacitance of the capacitor into a digital signal, and externally transmit the digital signal through the antenna in a wireless manner.

In some embodiments, a communication frequency range of the antenna and the RFID chip may include 860 MHz to 960 MHz.

In some embodiments, the capacitor may include: first and second electrodes separated from each other; and a dielectric material between the first and second electrodes, wherein the first and second electrodes include copper (Cu) or aluminum (Al), and the dielectric material includes CAB, polyimide, PMMA, pHEMA or PTFE polymer.

In some embodiments, an initial value of the electrostatic capacitance of the capacitor may be 3 pF to 30 pF.

In some embodiments, the capacitor may include: electrodes; and a dielectric material between the electrodes, wherein a level of a top surface of the dielectric material is higher than that of each top surface of the electrodes.

In some embodiments, at least a part of a bottom surface of the dielectric material may be positioned at a same level as that of each bottom surface of the electrodes.

In some embodiments, the capacitor may include a first electrode, a second electrode separated from the first electrode, and a dielectric material intervened between the first electrode and the second electrode; the first electrode may include a first reference electrode and a plurality of first protruding electrodes connected to the first reference electrode; the second electrode may include a second reference electrode and a plurality of second protruding electrodes connected to the second reference electrode; the first and second reference electrodes may be disposed to face each other; each of the first protruding electrodes may extend from the first reference electrode towards the second reference electrode; each of the second protruding electrodes may extend from the second reference electrode towards the first reference electrode; and the first protruding electrodes and the second protruding electrodes may be disposed alternately with a certain interval therebetween.

In some embodiments, the support body may be an adhesive layer, the support body may further include a bottom cover sheet on a bottom surface, and the top cover sheet and the bottom cover sheet may be independently detachable.

In some embodiments, a minimum distance between the capacitor and the RFID chip may be smaller than a minimum distance between the capacitor and the antenna.

In an embodiment of the inventive concept, a humidity sensor includes: a support body; a first capacitor, a second capacitor, an RFID chip and an antenna on the support body; a top cover sheet configured to cover the second capacitor, the RFID chip, and the antenna; and a hydrophobic material pattern on the first capacitor, wherein the first capacitor is exposed by the top cover sheet, the RFID chip is electrically connected to the first capacitor, the second capacitor and the antenna, the hydrophobic material pattern has a network shape including a plurality of holes, and initial electrostatic capacitance values of the first and second capacitors are identical.

In some embodiments, an electrostatic capacitance of the first capacitor may change according to an external humidity change, and an electrostatic capacitance of the second capacitor may be constant.

In some embodiments, transmittance of vapor through the hydrophobic material pattern may be larger than that of the vapor through the top cover sheet.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1A is a plan view showing a humidity sensor according to the inventive concept;

FIG. 1B is a plan view in which some components of FIG. 1A are omitted;

FIG. 1C is a cross-sectional view taken along line I-I′ of FIG. 1A;

FIG. 2 is a plan view in which the capacitor 120 of FIG. 1B is enlarged;

FIG. 3 is an enlarged view of aa portion of FIG. 1A;

FIG. 4 schematically illustrates a configuration of the RFID chip 130 of FIGS. 1A, 1B, and 1C;

FIG. 5A is a plan view showing a humidity sensor according to some embodiments;

FIG. 5B is a plan view in which some components of FIG. 5A are omitted;

FIG. 5C is a cross-sectional view taken along line I-I′ of FIG. 5A;

FIGS. 6A, 7A, 8A, 9A and 10A are plan views illustrating a manufacturing method for a humidity sensor according to the inventive concept;

FIGS. 6B, 7B, 8B, 9B and 10B are cross-sectional views taken along lines I-I′ of FIGS. 6A, 7A, 8A, 9A and 10A, respectively; and

FIG. 11 is a cross-sectional view of an application example of the inventive concept.

### DETAILED DESCRIPTION

The embodiments of the present invention will now be described with reference to the accompanying drawings for sufficiently understating a configuration and effects of the inventive concept. However, the inventive concept is not limited to the following embodiments and may be embodied in different ways, and various modifications may be made thereto. The embodiments are just given to provide complete disclosure of the inventive concept and to provide thorough understanding of the inventive concept to those skilled in the art. In the accompanying drawings, the sizes of the elements may be greater than the actual sizes thereof, for convenience of description, and the scales of the elements may be exaggerated or reduced.

Unless otherwise defined, all terms used herein have the same meaning as commonly understood by one of ordinary skill in the art to which this invention pertains. Hereinafter, the embodiments of the inventive concept will now be described in detail with reference to the accompanying drawings.

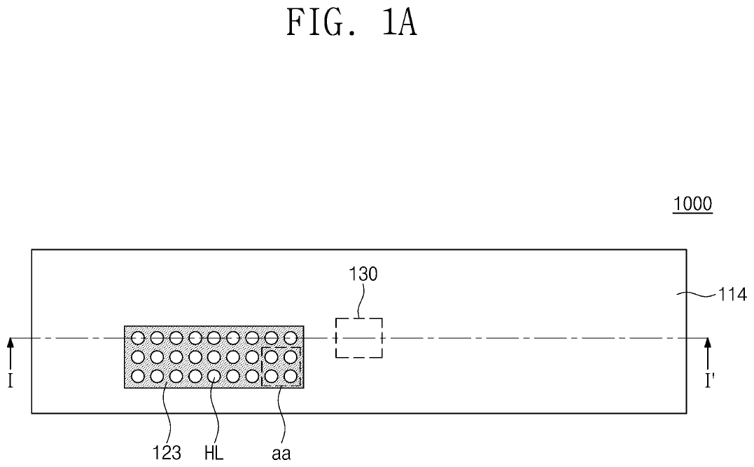

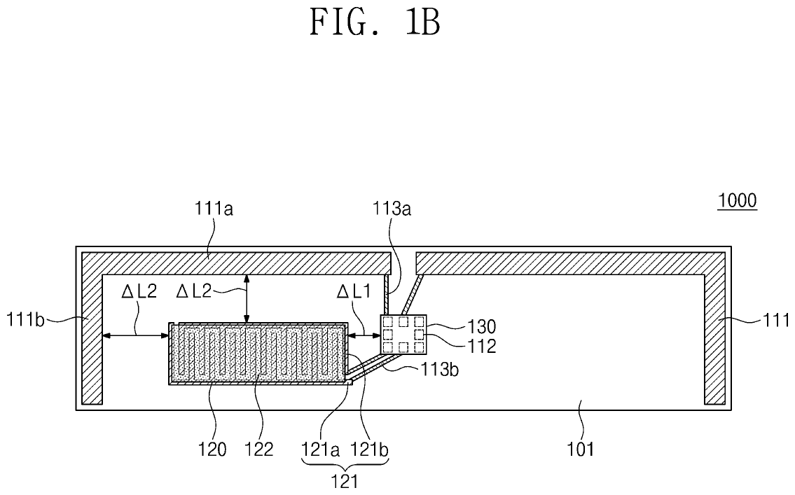

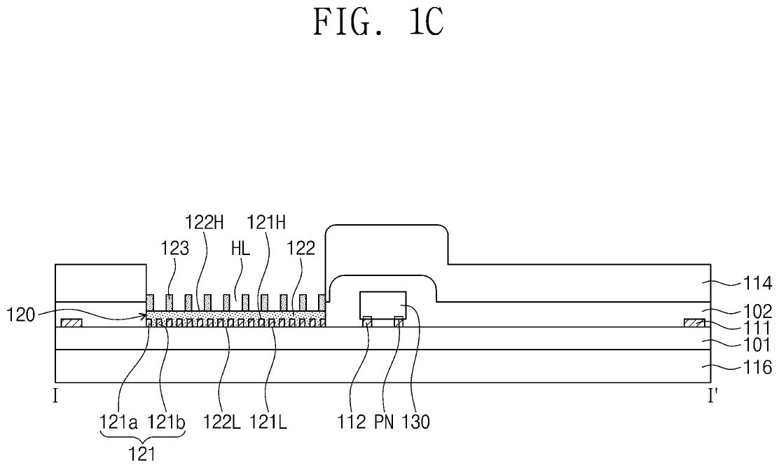

FIG. 1A is a plan view showing a humidity sensor according to the inventive concept. FIG. 1B is a plan view in which some components of FIG. 1A are omitted. FIG. 1C is a cross-sectional view taken along line I-I′ of FIG. 1A.

With reference to FIGS. 1A to 1C, a humidity sensor 1000 according to an embodiment of the inventive concept may include a support body 101, a capacitor 120, a radio frequency identification (RFID) chip 130, and a plurality of antennas 111.

The support body 101 may be a layer having adhesive on the bottom surface or the bottom and top surfaces. Hereinafter, the support body 101 may also be referred to as a first adhesive layer 101.

The RFID chip 130 and the plurality of antennas 111, which surround at least a portion of the sides of the RFID chip 130, may be provided on the support body 101. The antennas 111 may be disposed separately from each other. Each of the antennas 111 may include a first part 111a and a second part 111b connected to form an angle with each other, and may have a curved type. A wireless communication frequency of the antennas 111 may be in a range from 860 MHz to 960 MHz. Each of the antennas 111 may include copper or aluminum.

A plurality of pins or bumps PN may be provided in the bottom of the RFID chip 130. The pins and bumps PN may contact connection pads 112 on the support body 101. The connection pads 112 may contact first connection lines 113a and second connection lines 113b. The first connection lines 113a may respectively contact the antennas 111. The second connection lines 113b may contact the electrodes 121 of the capacitor 120.

The RFID chip 130 may be electrically connected to the antennas 111 and the capacitor 120 through the first connection lines 113a and the second connection lines 113b. Specifically, the RFID chip 130 may convert an electrostatic capacitance value of the capacitor 120 into a digital signal, and transmit the digital signal to the outside through the antennas 111. Details about the RFID chip 130 will be described later.

The capacitor 120 may be provided on the support body 101. The capacitor 120 may be disposed closer to the RFID chip 130 than to the antennas 111. In a planar perspective, the minimum distance ^{Δ}L1 between the capacitor 120 and the RFID chip 130 may be smaller than the minimum distance ^{Δ}L2 between the capacitor 120 and the antennas 111.

The capacitor 120 may include the electrodes 121 and a dielectric material 122. The electrodes 121 may include a first electrode 121a and a second electrode 121b separate from the first electrode 121a.

The dielectric material 122 may be filled between the electrodes 121. At least a part of the bottom surface 122L of the dielectric material 122 may be positioned at the same level as those of the bottom surfaces 121L of the electrodes 121. The dielectric material 122 may cover the top surfaces of the electrodes 121. The level of the top surface 122H of the dielectric material 122 may be higher than those of the top surfaces 121H of the electrodes 121. In other words, when external water vapor enters the capacitor 120, the dielectric material 122 may contact the water vapor prior to the electrodes 121.

The first electrode 121a and the second electrode 121b may include copper (Cu) or aluminum (Al). The dielectric material 122 may include at least one among CAB, polyimide, PMMA, pHEMA or PTFE polymer.

A hydrophobic material pattern 123 may be provided on the capacitor 120. Details about the hydrophobic material pattern 123 will be described later.

A top cover sheet 114 may be provided which selectively covers the support body 101. A second adhesive layer 102 may be intervened between the top cover sheet 114 and the support body 101. The capacitor 120 and the hydrophobic material pattern 123 may be exposed by the top cover sheet 114 and the second adhesive layer 102. The top cover sheet 114 may include paper or a release liner. The release liner may include a polymer such as polyethylene terephthalate (PET). In some embodiments, the top cover sheet 114 may be detachable from the support body 101.

A bottom cover sheet 116 may be provided on the bottom surface of the support body 101. The bottom cover sheet 116 may include paper or a release liner. In some embodiments, the bottom cover sheet 116 may be detachable from the support body 101.

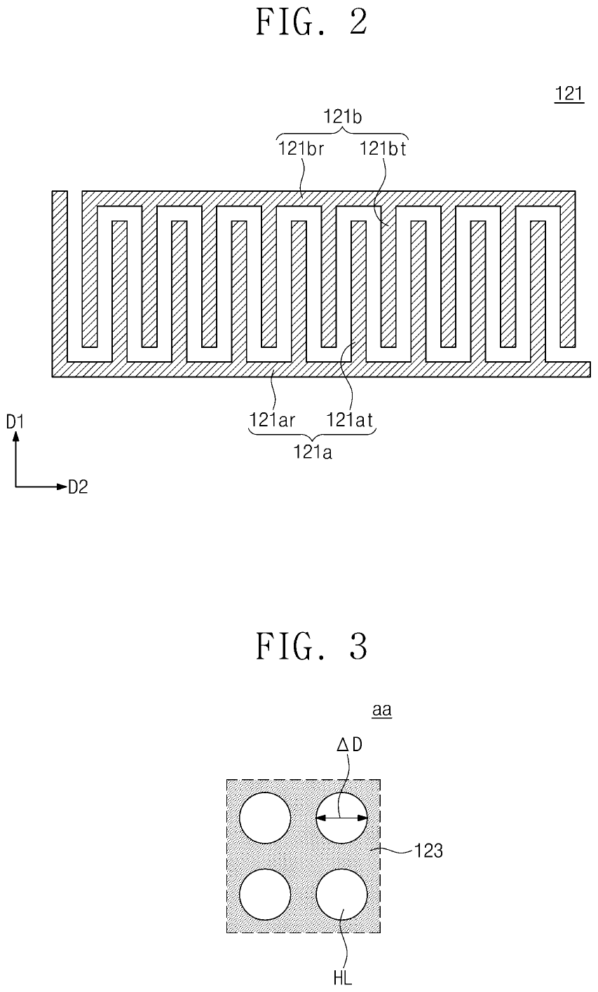

FIG. 2 is a plan view in which the electrode 121 of FIG. 1B is enlarged.

With reference to FIGS. 1B, 1C and 2, the first electrode 121a may include a first reference electrode 121ar, and a plurality of protruding electrodes 121at connected to the first reference electrode 121ar. The second electrode 121b may include a second reference electrode 121br, and a plurality of protruding electrodes 121bt connected to the second reference electrode 121br. The first reference electrode 121ar and the second reference electrode 121br may be disposed to face each other along a first direction D1.

Each of the first protruding electrodes 121at may extend from the first reference electrode 121ar towards the second reference electrode 121br, and each of the second protruding electrodes 121bt may extend from the second reference electrode 121br towards the first reference electrode 121ar. The first protruding electrodes 121at and the second protruding electrodes 121bt may be disposed alternately along a second direction D2 vertical to the first direction D1 with a certain interval therebetween. In other words, the capacitor 120 may be a horizontal capacitor in which the first and second protruding electrodes 121at and 121bt are disposed along the second direction D2.

An electrostatic value of the capacitor 120 may be set in an earlier time, and the set electrostatic capacitance value may be 3 to 30 pF.

FIG. 3 is an enlarged view of aa portion of FIG. 1A.

With reference to FIG. 3, the hydrophobic material pattern 123 may include a plurality of holes HL having the diameter ^{Δ}D of several to several hundred nanometers. The hydrophobic material pattern 123 may have a network shape. The hydrophobic material pattern 123 may include a hydrophobic material that is a polymer material, or an organic-inorganic hybrid material. The polymer material may include PET, for example. The organic-inorganic hybrid material may be a silica-polymer composite.

Each of the plurality of holes HL has the diameter ^{Δ}D of several hundred nanometers, and thus external water vapor may pass through the hydrophobic material pattern 123, but a droplet may not pass therethrough. In addition, the hydrophobic material pattern 123 employs a hydrophobic material, and thus water hold-up on the surface of the capacitor 120 may be prevented, and a measurement error that the capacitor 120 senses humidity higher may be prevented.

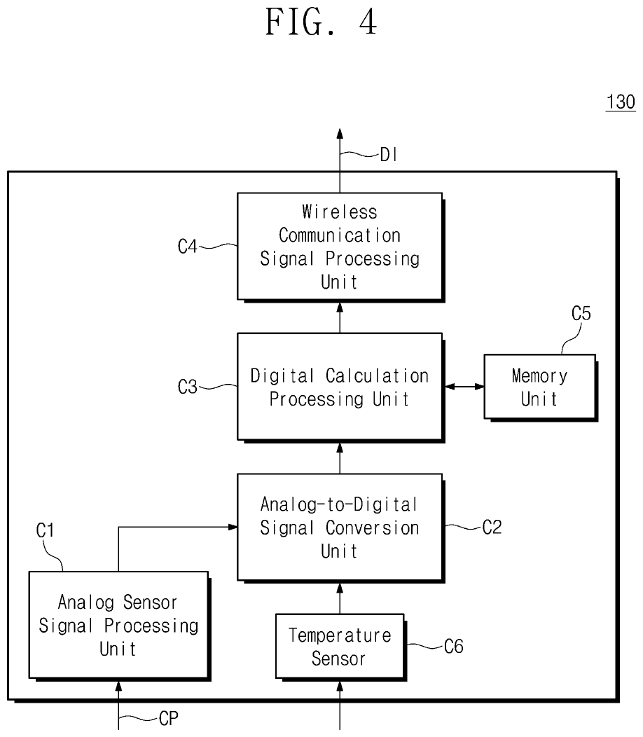

FIG. 4 schematically illustrates a configuration of the RFID chip 130 of FIGS. 1A, 1B, and 1C.

With reference to FIG. 4, the RFID chip 130 may include an analog sensor signal processing unit C1, an analog-to-digital signal conversion unit C2, a digital calculation processing unit C3, a wireless communication signal processing unit C4, and a memory unit C5.

The electrostatic value CP, which is an analog value of the capacitor 120, is converted to a digital signal D1 by sequentially proceeding through the analog sensor signal processing unit C1, the analog-to-digital signal conversion unit C2, the digital calculation processing unit C3, and the wireless communication signal processing unit C4 in the RFID chip 130, and the digital signal D1 may be delivered to an external reader through the antennas 111.

Specifically, the analog sensor signal processing unit C1 and the analog-to-digital signal conversion unit C2 may output, as a voltage, the electrostatic capacitance value received from the capacitor 120. Required information may be extracted from the output voltage by the digital calculation processing unit C3. The memory unit C5 may store information from the digital calculation processing unit C3. The extracted information may be transmitted to the external reader through the wireless communication signal processing unit C4 and the antennas 111. A wireless communication frequency of the RFID chip 130 may include a frequency in a range from 860 MHz to 960 MHz.

According to some embodiments, the RFID chip 130 may further include a temperature sensor C6. Additional temperature-related information may be transmitted in a wireless manner through the temperature sensor C6 embedded in one RFID chip 130.

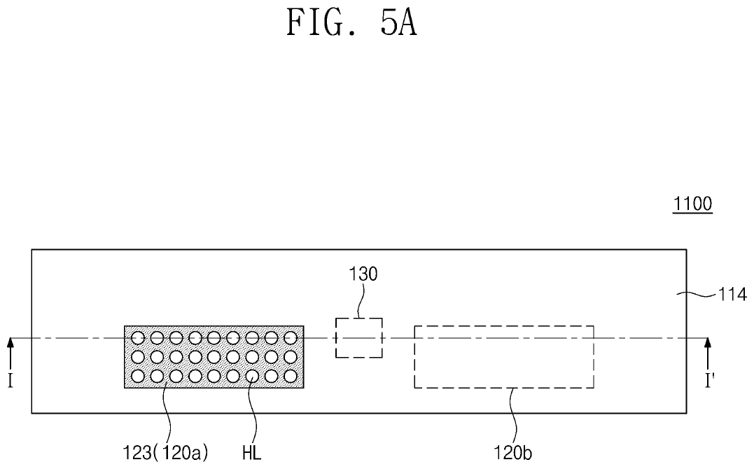

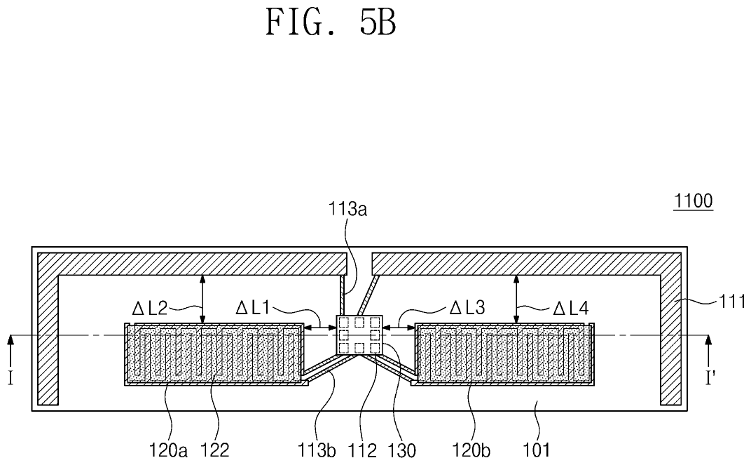

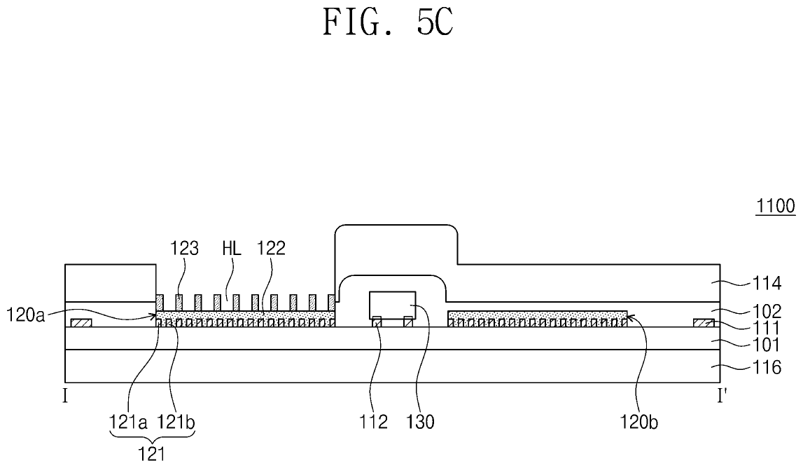

FIG. 5A is a plan view showing a humidity sensor 1100 according to some embodiments. FIG. 5B is a plan view in which some components of FIG. 5A are omitted. FIG. 5C is a cross-sectional view taken along line I-I′ of FIG. 5A. Hereinafter, detailed descriptions about those described in the above with reference to FIGS. 1A to 1C will be omitted.

With reference to FIGS. 5A to 5C, a first capacitor 120a and a second capacitor 120b may be disposed on the support body 101. The first capacitor 120a and the second capacitor 120b may be disposed closer to the RFID chip 130 than to the antennas 111. In a planar perspective, the minimum distance ^{Δ}L1 between the first capacitor 120a and the RFID chip 130 may be smaller than the minimum distance ^{Δ}L2 between the first capacitor 120a and the antennas 111. The minimum distance ^{Δ}L3 between the second capacitor 120b and the RFID chip 130 may be smaller than the minimum distance ^{Δ}L4 between the second capacitor 120b and the antennas 111.

The RFID chip 130 may be electrically connected to the first capacitor 120a and the second capacitor 120b through the second connection lines 113b.

The hydrophobic material pattern 123 may be provided on the first capacitor 120a. The second adhesive layer 102 and the top cover sheet 114 may be sequentially provided on the second capacitor 120b. The first capacitor 120a and the hydrophobic material pattern 123 may be exposed by the second adhesive layer 102 and the top cover sheet 114.

The second capacitor 120b may be substantially the same as the first capacitor 120a. Under a condition that external humidity is very small, an initial electrostatic capacitance value of the second capacitor 120b may be substantially the same as that of the first capacitor 120a. The initial electrostatic values of the first capacitor 120a and the second capacitor 120b may have a range from 3 pF to 30 pF.

The second capacitor 120b may operate as a reference capacitor. Since the top cover sheet 114 is provided on the top of the second capacitor 120b and the second capacitor 120b is not exposed to external water vapor, the electrostatic capacitance value may rarely change according to a humidity change. The transmittance of water vapor through the hydrophobic material pattern 123 may be very larger than that of water vapor through the top cover sheet 114. Since the second capacitor 120b is identical to the first capacitor 120a, the electrostatic capacitance changes thereof may be similar with respect to an external temperature change or the like.

Accordingly, when the electrostatic capacitance value of the first capacitor 120a and the electrostatic capacitance value of the second capacitor 120b are calculated and processed, only humidity-related sensing information may be possibly extracted. In this case, the accuracy of the humidity sensor may be improved.

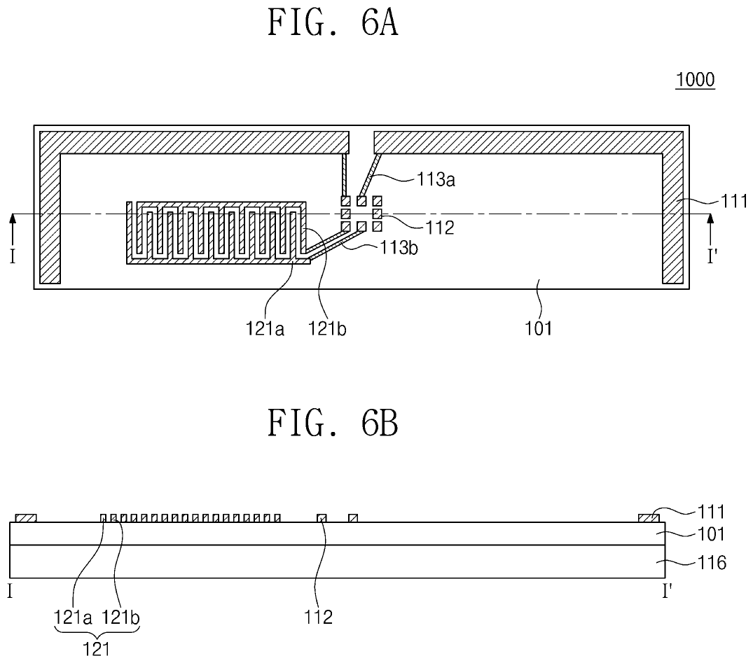

FIGS. 6A, 7A, 8A, 9A and 10A are plan views illustrating a manufacturing method for a humidity sensor according to the inventive concept. FIGS. 6B, 7B, 8B, 9B and 10B are cross-sectional views taken along lines I-I′ of FIGS. 6A, 7A, 8A, 9A and 10A, respectively.

With reference to FIGS. 6A and 6B, a bottom cover sheet 116 on which the first adhesive layer 101 is coated on one side may be provided.

The antennas 111, the connection pads 112, the connection lines 113a and 113b, the first electrode 121a, and the second electrode 121b may be formed on the support body 101.

The antennas 111, the connection pads 112, the connection lines 113a and 113b, the first electrode 121a, and the second electrode 121b may be formed through a screen printing process using a shadow mask (not shown) by employing copper or aluminum in a paste type.

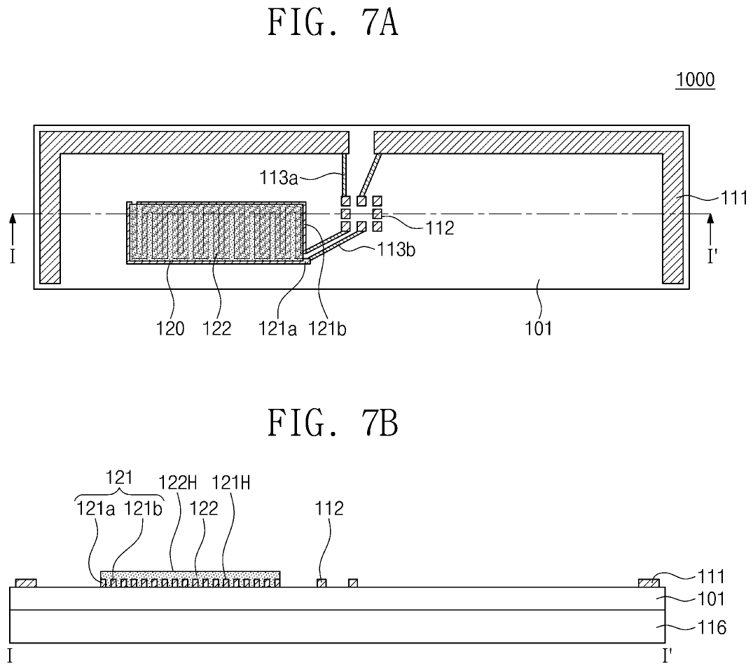

With reference to FIGS. 7A and 7B, a dielectric material 122 filling between the electrodes 121a and 121b may be formed. The dielectric material 122 may be formed to cover the top surfaces of the first electrode 121a and the second electrode 121b. The dielectric material 122 may be formed, for example, through a screen printing process using the shadow mask (not shown). The level of the top surface 122H of the dielectric material 122 may be higher than that of the top surfaces 121H of the electrodes 121.

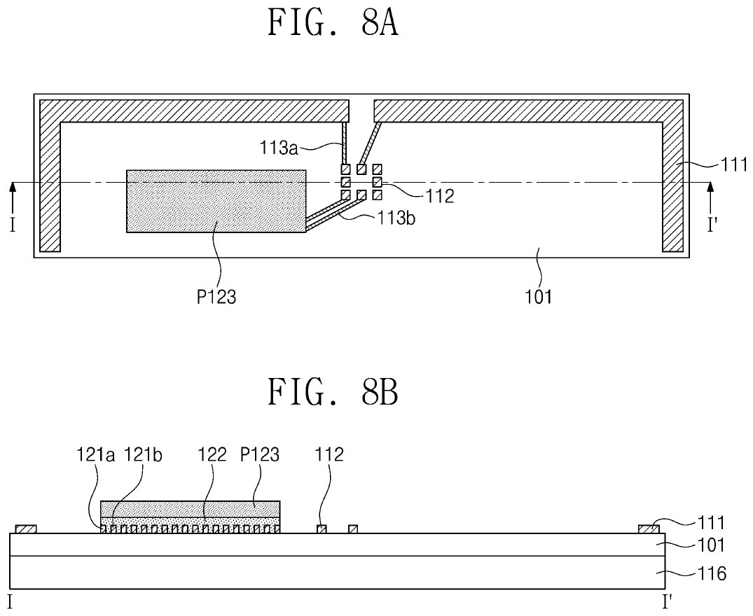

With reference to FIGS. 8A and 8B, the hydrophobic material layer P123 may be selectively formed on the capacitor 120. The hydrophobic material layer P123 may cover the top surface of the capacitor 120. The hydrophobic material layer P123 may be formed, for example, through a screen printing process. The hydrophobic material P123 may include a polymer material or an organic-inorganic hybrid material. The polymer material may include PET, for example. The organic-inorganic hybrid material may be a silica-polymer composite, for example.

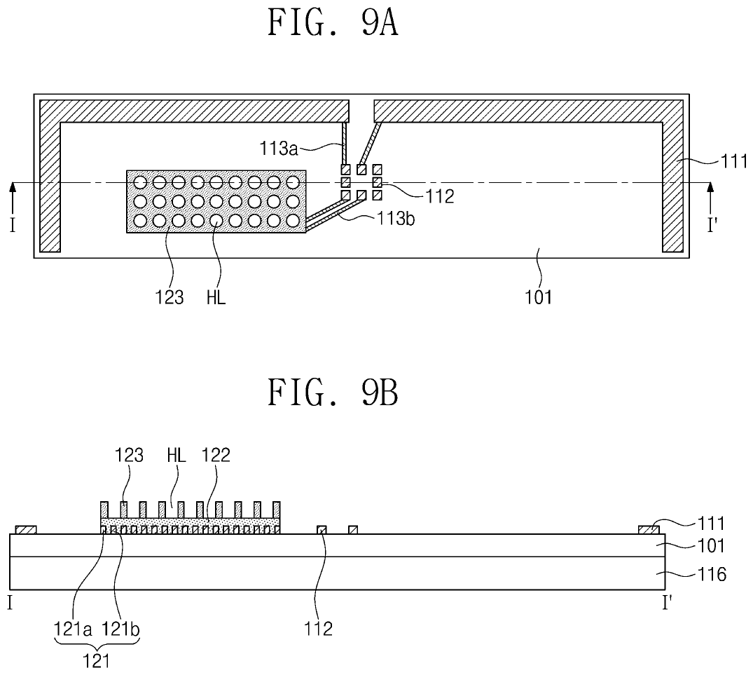

With reference to FIGS. 9A and 9B, the hydrophobic material pattern 123 may be formed through a nano imprinting scheme using a stamp (not shown). During the nano imprinting process, the plurality of holes HL, each having the diameter of several nanometers and penetrating through the hydrophobic material layer P123, may be formed.

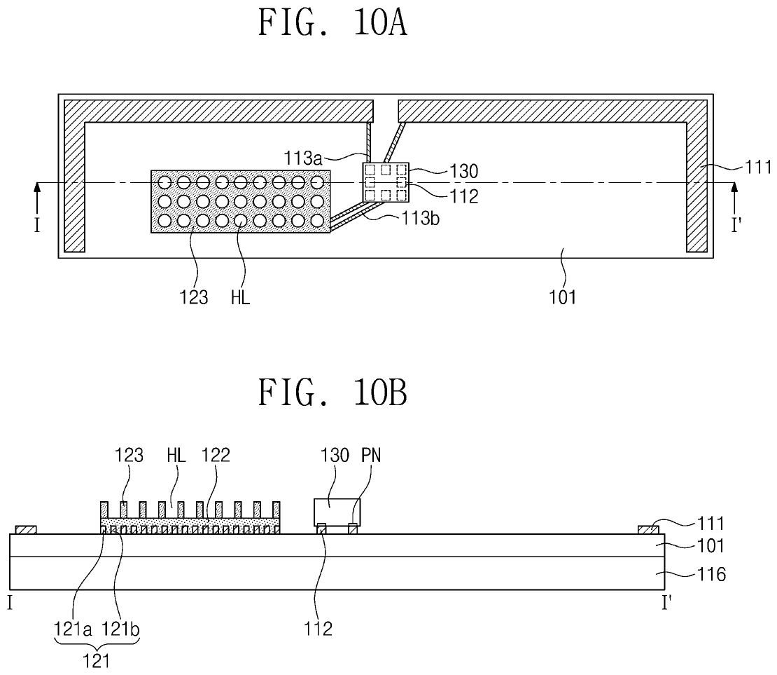

With reference to FIGS. 10A and 10B, the RFID chip 130 may be embedded on the support body 101. The RFID chip 130 may be embedded so that the pins or bumps PN of the RFID chip 130 may be aligned with the connection pads 112. The RFID chip 130 may be embedded through, for example, thermal compression using a laser.

With reference to FIGS. 1A and 1C again, the top cover sheet 114 may be formed on a part of the support body 101. The top cover sheet 114 may be adhered to the top surface of the support body 101 through the second adhesive layer 102 coated on the bottom surface. The capacitor 120 and the hydrophobic material pattern 123 may be exposed by the top cover sheet 114 and the second adhesive layer 102.

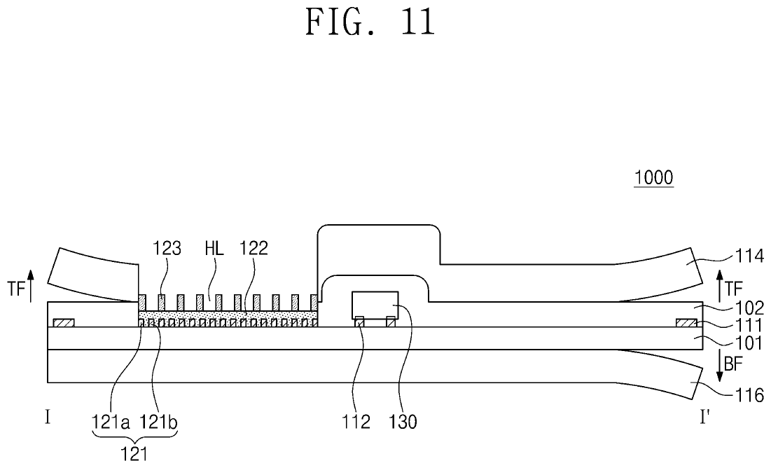

FIG. 11 is a cross-sectional view showing an application example of the humidity sensor 1000 according to the inventive concept.

Referring to FIG. 11, detachment TF of the top cover sheet 114 and detachment BF of the bottom cover sheet 116 may be independently executed according to a measurement target.

For example, at the time of measuring surface humidity of the measurement target such as a leaf of crops, the top cover sheet 114 is detached TF and the second adhesive layer 102 may be attached to the measurement target. For another example, in case where the measurement target is the environment such as a greenhouse, the bottom cover sheet 116 is detached BF and the first adhesive layer 101 may be attached to the measurement target.

The humidity sensor according to an embodiment of the inventive concept includes the structure of the humidity sensor, which selectively exposes the capacitor, and the hydrophobic material pattern on the capacitor, and thus may prevent water hold-up on the top surface of the capacitor. In addition, as water vapor effectively reaches the capacitor, and thus humidity may be sensed as soon as possible with high measurement accuracy.

According to the various embodiments of the inventive concept, the humidity may be measured with high accuracy within a fast response time through the humidity sensor.

The exemplary embodiments of the present disclosure have been described above with reference to the accompanying drawings, but those skilled in the art will understand that the present disclosure may be implemented in another concrete form without changing the technical spirit or an essential feature thereof. Therefore, the aforementioned exemplary embodiments are all illustrative and are not restricted to a limited form. Therefore, these embodiments as described above are only proposed for illustrative purposes and do not limit the present disclosure.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A humidity sensor comprising:
a support body;
an RFID chip, an antenna, and a capacitor on the support body;
a top cover sheet on the RFID chip and the antenna; and
a hydrophobic material pattern on the capacitor,
wherein the capacitor is exposed by the top cover sheet, the hydrophobic material pattern has a network shape comprising a plurality of holes, and an electrostatic capacitance of the capacitor changes according to humidity.

2. The humidity sensor of claim 1, wherein the hydrophobic material pattern comprises a polymer material or an organic-inorganic hybrid material.

3. The humidity sensor of claim 1, wherein each of the holes exposes a top surface of a dielectric material of the capacitor.

4. The humidity sensor of claim 1, wherein the RFID chip converts a value of the electrostatic capacitance of the capacitor into a digital signal, and externally transmits the digital signal through the antenna in a wireless manner.

5. The humidity sensor of claim 1, wherein a communication frequency range of the antenna and the RFID chip comprises 860 MHz to 960 MHz.

6. The humidity sensor of claim 1, wherein the capacitor comprises:
first and second electrodes separated from each other; and
a dielectric material between the first and second electrodes,
wherein the first and second electrodes comprise copper (Cu) or aluminum (Al), and the dielectric material comprises CAB, polyimide, PMMA, pHEMA or PTFE polymer.

7. The humidity sensor of claim 1, wherein an initial value of the electrostatic capacitance of the capacitor is 3 pF to 30 pF.

8. The humidity sensor of claim 1, wherein the capacitor comprises:
electrodes; and
a dielectric material between the electrodes,
wherein a level of a top surface of the dielectric material is higher than that of each top surface of the electrodes.

9. The humidity sensor of claim 8, wherein at least a part of a bottom surface of the dielectric material is positioned at a same level as that of each bottom surface of the electrodes.

10. The humidity sensor of claim 1, wherein the capacitor comprises a first electrode, a second electrode separated from the first electrode, and a dielectric material intervened between the first electrode and the second electrode,
the first electrode comprises a first reference electrode and a plurality of first protruding electrodes connected to the first reference electrode,
the second electrode comprises a second reference electrode and a plurality of second protruding electrodes connected to the second reference electrode,
the first and second reference electrodes are disposed to face each other,
each of the first protruding electrodes extends from the first reference electrode towards the second reference electrode,
each of the second protruding electrodes extends from the second reference electrode towards the first reference electrode, and
the first protruding electrodes and the second protruding electrodes are disposed alternately with a certain interval therebetween.

11. The humidity sensor of claim 1, wherein the support body is an adhesive layer,
the support body further comprises a bottom cover sheet on a bottom surface, and
the top cover sheet and the bottom cover sheet are independently detachable.

12. The humidity sensor of claim 1, wherein a minimum distance between the capacitor and the RFID chip is smaller than a minimum distance between the capacitor and the antenna.

13. A humidity sensor comprising:
a support body;
a first capacitor, a second capacitor, an RFID chip and an antenna on the support body;
a top cover sheet configured to cover the second capacitor, the RFID chip, and the antenna; and
a hydrophobic material pattern on the first capacitor,
wherein the first capacitor is exposed by the top cover sheet,
the RFID chip is electrically connected to the first capacitor, the second capacitor and the antenna,
the hydrophobic material pattern has a network shape comprising a plurality of holes, and
initial electrostatic capacitance values of the first and second capacitors are identical.

14. The humidity sensor of claim 13, wherein an electrostatic capacitance of the first capacitor changes according to an external humidity change, and
an electrostatic capacitance of the second capacitor is constant.

15. The humidity sensor of claim 13, wherein transmittance of vapor through the hydrophobic material pattern is larger than that of the vapor through the top cover sheet.
